(19) United States
(12) Patent Application Publication
(10) Pub. No.: US 2018/0210619 A1
(43) Pub. Date: Jul. 26, 2018

(54) AUTOMATED USER INTERFACE DESIGN IMPROVEMENT

(71) Applicant: Microsoft Technology Licensing, LLC, Redmond, WA (US)

(72) Inventors: David Mowatt, Dublin (IE); Ashleigh Conway, Dublin (IE)

(21) Appl. No.: 15/416,469

(22) Filed: Jan. 26, 2017

(51) Int. Cl. G06F 3/0484; G06F 9/44

(52) U.S. Cl. CPC G06F 3/0484; G06F 9/4443

(57) ABSTRACT

Systems and methods for automated interface design improvement. The method includes receiving, with an electronic processor, a manifest associated with a first application. The manifest includes an element indicator corresponding to an adjustable-user-interface-element of the first application, an adjustment range associated with the adjustable-user-interface-element, and a user satisfaction criterion associated with the adjustable-user-interface-element. The method includes assigning, with the electronic processor, an initial value for the adjustable-user-interface-element, the initial value being within the adjustment range. The method includes receiving a configuration request for the first application. The method includes transmitting the initial value. The method includes receiving, from the user device, a user success score for the user satisfaction criterion. The method includes generating, with the electronic processor, an adjusted value for the adjustable-user-interface-element based on the user success score. The method includes setting, with the electronic processor, the initial value for the adjustable-user-interface-element to the adjusted value.

### FIELD

Embodiments relate to automatically improving user interfaces.

### SUMMARY

Software application user interfaces include interface elements, which a user manipulates to interact with the application (for example, to enter or retrieve data, navigate the application, select application functions, and the like). User interface elements (for example, buttons, scroll bars, slider controls, fonts, menus, and the like) may vary in size and placement within the application. A particular configuration of user interface elements (for example, what sized elements are positioned where within the application) may improve productivity for some users of the application, while hindering the productivity of other users. To address this concern, some applications allow users to change some user interface settings in the application. However, changing the settings provided by a software developer may not be sufficient to guarantee user satisfaction because the user interface customization options provided by the software developer are limited. Users may not realize such customization options exist, may not think to choose them, or may not have a means to know their preferred setting.

Embodiments described herein provide, among other things, a system, including an automated improvement platform that implements subtle changes in an application, website other software program's design to improve predefined metrics. The automated improvement platform automatically creates different user interface designs for an application, website, or other software program on an individualized basis for users. Moreover, the automated improvement platform provides the capability to use knowledge from similar users to influence various design experiments that may be applied for a specific user.

Currently, users are required to individually change the settings on each application that they own or use. In some situations, users must choose application settings at a platform level (for example, an operating system or internet browser may include some coarse settings, which are universally applied. Changing the settings for each application the user uses requires using the limited number of configurations that are typically predefined by the developer. As a result, there is also no guarantee that the options provided by the developer will be able to satisfy the requirements of the users.

Embodiments provided herein describe an application platform that provides a service for all applications that would, for a subset of the user base, make small, personalized modifications to the user interface elements while monitoring user engagement thereby improving the experience for each application for each user.

The modifications include element or font sizes and colors, adjusting the spacing within or between various elements or objects within the user interface. The preferred configurations for each user can be stored so that future applications by that developer or by other developers can leverage those preferences. Stored preferences can also be used to modify the default design for the application if it was found that the majority of users preferred a particular configuration.

The automated improvement platform may be implemented as an automatically or constantly improving AB testing platform which searches for the preferred configuration for a user. The automated improvement platform may also use its knowledge of similar users or similar applications to determine other likely improvements to try for a particular user, based on past improvements for users similar to the particular user.

One embodiment provides an automated improvement system. The system includes an electronic processor configured to receive a manifest associated with a first application. The manifest includes an element indicator corresponding to an adjustable-user-interface-element of the first application, an adjustment range associated with the adjustable-user-interface-element, and a user satisfaction criterion associated with the adjustable-user-interface-element. The electronic processor is configured to assign an initial value for the adjustable-user-interface-element, the initial value being within the adjustment range. The electronic processor is configured to receive, from a user device, a configuration request for the first application. The electronic processor is configured to transmit, to the user device, the initial value. The electronic processor is configured to receive, from the user device, a user success score for the user satisfaction criterion. The electronic processor is configured to generate an adjusted value for the adjustable-user-interface-element based on the user success score. The electronic processor is configured to set the initial value for the adjustable-user-interface-element to the adjusted value.

Another embodiment provides a method for automatically improving design-associated aspects of user interface elements. The method includes receiving, with an electronic processor, a manifest associated with a first application. The manifest includes an element indicator corresponding to an adjustable-user-interface-element of the first application, an adjustment range associated with the adjustable-user-interface-element, and a user satisfaction criterion associated with the adjustable-user-interface-element. The method includes assigning, with the electronic processor, an initial value for the adjustable-user-interface-element, the initial value being within the adjustment range. The method includes receiving, from a user device, a configuration request for the first application. The method includes transmitting, to the user device, the initial value. The method includes receiving, from the user device, a user success score for the user satisfaction criterion. The method includes generating, with the electronic processor, an adjusted value for the adjustable-user-interface-element based on the user success score. The method includes setting, with the electronic processor, the initial value for the adjustable-user-interface-element to the adjusted value.

Another embodiment provides a non-transitory, computer-readable medium containing computer-executable instructions that when executed by one or more processors cause the one or more electronic processors to receive a manifest associated with a first application, the manifest including an element indicator corresponding to an adjustable-user-interface-element of the first application, an adjustment range associated with the adjustable-user-interface-element, and a user satisfaction criterion associated with the adjustable-user-interface-element. The instructions also cause the one or more processors to assign an initial value for the adjustable-user-interface-element, the initial value being within the adjustment range. The instructions also cause the one or more processors to receive, from a user device, a configuration request for the first application. The instructions also cause the one or more processors to transmit, to the user device, the initial value. The instructions also cause the one or more processors to receive, from the user device, a user success score for the user satisfaction criterion. The instructions also cause the one or more processors to generate an adjusted value for the adjustable-user-interface-element based on the user success score. The instructions also cause the one or more processors to set the initial value for the adjustable-user-interface-element to the adjusted value.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 schematically illustrates a system for automatically improving the design-associated aspects of user interface elements in one or more application, in accordance with some embodiments.

FIG. 2 schematically illustrates the computing device shown in FIG. 1 according to some embodiments.

FIG. 3 is a flow diagram illustrating a method for automatically improving the design-associated aspects of user interface elements of an application according to some embodiments.

FIG. 4 is a flow diagram illustrating an interaction between a developer portal and the system in FIG. 1 according to some embodiments.

FIG. 5 is a flow diagram illustrating an interaction between a user and the system shown in FIG. 1 according to some embodiments.

FIG. 6 is a flow diagram illustrating a user interaction with an application according to some embodiments.

FIG. 7 is a flow diagram illustrating an interaction between the automated improvement platform and an application according to some embodiments.

FIG. 8 is a flow diagram illustrating an interaction between the developer and the developer portal according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

Before any embodiments are explained in detail, it is to be understood that these embodiments are not limited in their application to the details of construction and the arrangement of components set forth in the following description or illustrated in the accompanying drawings. Other embodiments are possible and the embodiments described are capable of being practiced or of being carried out in various ways. Some embodiments may be a machine- or computer-implemented method, a non-transitory, computer-readable medium having a set of instructions stored thereon detailing a method that may be carried out by at least one electronic processor, or a user interface narrator for a computing device.

Designing software applications (for example, mobile “apps” or websites) involves an understanding of user interface design principles and accessibility design. Delivering experiences that work well for all users requires a degree of personalization that is very difficult to achieve with a “one size fits all” design. Embodiments provided herein allow a developer to take an approach that personalizes the experience for users who are known to the system, as well as personalizing the experience for new users, which the system knows nothing about, and automatically refine the design by experimenting with different user interface aspects of the application. The experimentation is based on known design principles, so the developer does not have to be an expert. The experimentation helps to improve the user experience over time. Because the experimentation may also be tailored on a per user basis, it allows for building one application, with a subtly different design based on the needs and preferences of a current user. Embodiments automatically provide customized user experiences, rather than a one size fits all approach.

This automated improvement system reduces the requirements for developer expertise in the areas of design, accessibility, and experimentation by automatically modifying the designs of applications in an experimental way. The resulting user interaction is monitored to determine a preferred configuration for the user interface. Once the products have been built, the automated improvement system identifies each of the user interface elements. Based on a predefined set of design principles, various modifications are made to the elements. Metrics are used to measure the effectiveness of the design variations.

When users interact with an application, they are assigned a variation of the user interface design. Their engagement with the product is monitored and compared with a group of users in a control group (that is, users who receive an application with an unmodified user interface design). When statistical significance has been reached for a given user, that user may be assigned the design, for example, because it improved the key metrics the most for the user. The modification process may continue in an iterative fashion to continuously improve the user interface for the application. In some embodiments, the next user interface modification may be determined based on successful modifications made based on other users' experiences or, based on other similar users where possible.

This process continues until the system finds a preferred user interface configuration for each user. Accordingly, many users of an application operate slightly different variations of the product, tailored to suit their needs and behaviors. The developer may be able to view the different preferred user interface configurations for users, enabling the developer to see the user interface configurations that result in the application being most effective for users.

In some embodiments, user interface configurations are based on device size, to factor in and account for different screen sizes. For example, while user A may have shown a preference for smaller buttons on a smart phone, use of a tablet with a larger screen may evince a preference for larger buttons.

In some embodiments, the system stores preferences for a specific user and device size across different applications. For example, if it has already been determined that a particular user is more effective with larger buttons, or will scroll to read the entire screen regardless, the preference for larger buttons may be carried across to other designs. Accordingly, the more products developed on this platform, the faster the improved designs can be established for each product.

In some embodiments, the automated improvement platform is able to recognize users who have their devices set up based on particular disabilities and/or preferences. Patterns may be established between these users to help to predict the best configuration to be used for a given user. For example, if it is found that the user has their device set up in a particular manner, it is a reasonable to begin with configurations that have proved most popular with people with similar setups.

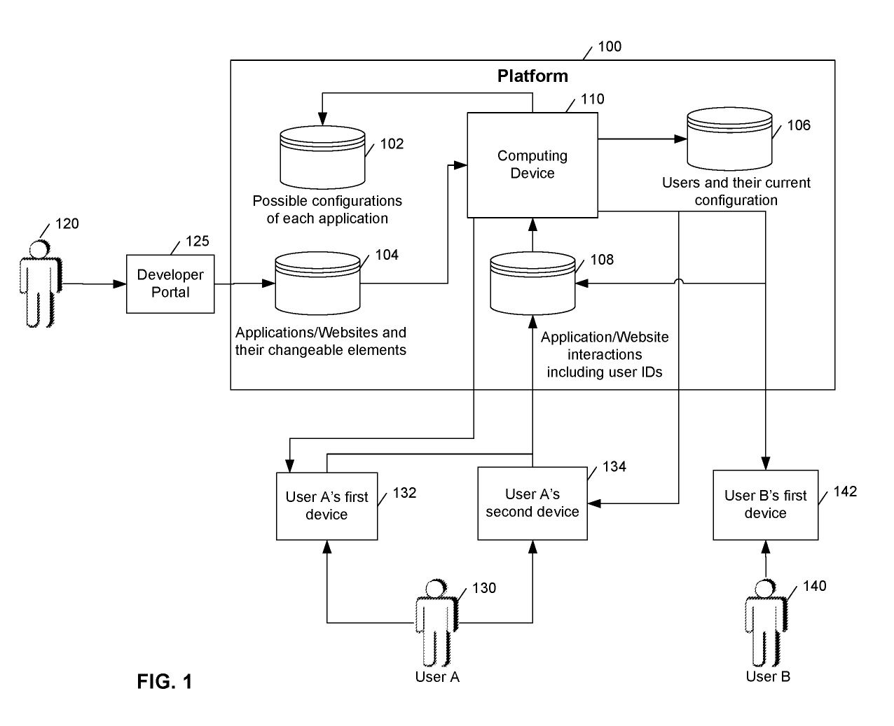

FIG. 1 illustrates a block diagram of a system 100 for automatically improving the design-associated aspects of user interface elements in one or more applications created by a developer 120 and used by users 130 (User A) and 140 (User B), in accordance with some embodiments. The system 100 includes a computing device 110, and databases 102, 104, 106 and 108. It should also be understood that the system 100 is provided as an example. Other example embodiments may include more or fewer of each of the illustrated components, may combine some components, or may include additional or alternative components. For example, may include multiple computing devices 110 (for example, communicatively coupled via one or more networks or data busses). In some embodiments, the computing device 110 may be part of a cloud-based or distributed computing environment. In another example, each database may be a database housed on a suitable database server communicatively coupled to and accessible by the computing device 110, or may be a part of a cloud-based database system. In some embodiments, the computing device 110 and the databases 102, 104, 106 and 108 (or portions thereof) may reside on the same physical machine or in the same data center.

The database 102 may include possible configurations of each application used by User A and User B. The database 104 may include information regarding various applications (or websites) and what types of user interface elements of the applications are changeable. The database 106 may include a listing of users and various configurations of the applications used by User A and User B. The database 108 may include information associated with several application/website interactions related to various users. In some embodiments, the database 104 may store the actual applications (for example, as in the case of an “app store”). In some embodiments, the database 104 stores pointers to the applications and a manifest for the application (described in detail below). Some embodiments employ a combination of approaches.

As shown in FIG. 1, the developer 120 may communicate with the system 100 using a developer portal 125. In the example shown in FIG. 1, User A may use a first device 132 (for example, a smart phone) and a second device 134 (for example, a tablet or a laptop). Similarly User B may use a first device 142 (for example, a smartphone or a smart watch). The first device 132 and the second device 134 are configured to download and execute, or access via a network, one or more applications or websites, which, as described in detail below, communicate with the system 100 regarding the configuration of their respective user interface elements. The User A's first device 132, User A's second device 134 and User B's first device 142 are communicatively coupled to the system 100.

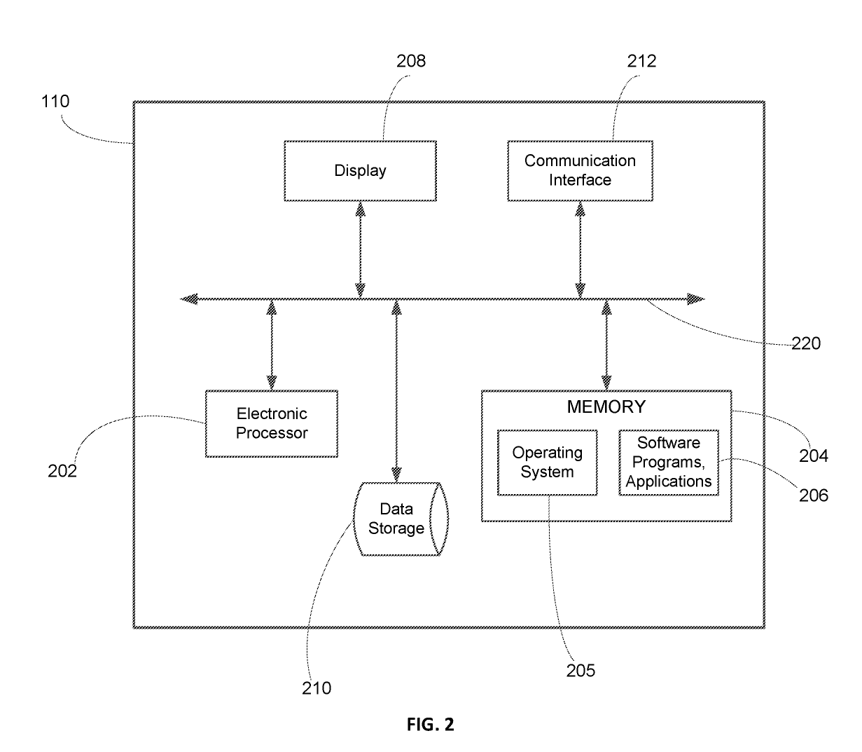

FIG. 2 illustrates a block diagram of the computing device 110 shown in FIG. 1 in accordance with some embodiments. The computing device 110 may combine hardware, software, firmware, and system on-a-chip technology to implement a narration controller. The computing device 110 may include an electronic processor 202, a memory 204, a display 208, data storage device 210, a communication interface 212 and a bus 220. The memory 204 may include an operating system 205 and one or more software programs 206. The electronic processor 202 may include at least one processor or microprocessor that interprets and executes a set of instructions stored in the memory 204. The one or more software programs, applications) 208 may be configured to implement the methods described herein. The memory 204 is a non-transitory computer-readable medium. As used in the present application a non-transitory computer-readable medium comprises all computer-readable media except for a transitory, propagating signal. The memory 204 may include random access memory (RAM)), read only memory (ROM), and combinations thereof. The memory 204 may have a distributed architecture, where various components are situated remotely from one another, but may be accessed by the electronic processor 202.

The data storage device 210 may include a non-transitory, tangible, machine-readable storage medium that stores machine-readable code or instructions. In one example, the data storage device 210 stores a set of instructions detailing a method provided herein that when executed by one or more processors cause the one or more processors to perform the method. The data storage device 210 may also be a database or a database interface for storing an application module. In one example, the data storage device 210 is located external to the computing device 110.

The bus 220, or other component interconnection, may permit communication among the components of the computing device 110. The bus 220 may be, for example, one or more buses or other wired or wireless connections, as is known in the art. The bus 220 may have additional elements, which are omitted for simplicity, such as controllers, buffers (for example, caches), drivers, repeaters and receivers, or other similar components, to enable communications. The bus 220 may also include address, control, data connections, or a combination of the foregoing to enable appropriate communications among the aforementioned components.

The communication interface 212 provides the computing device 110 a communication gateway with an external network (for example, a wireless network, the internet, etc.). The communication interface 212 may include, for example, an Ethernet card or adapter or a wireless local area network (WLAN) card or adapter (for example, IEEE standard 802.11a/b/g/n). The communication interface 212 may include address, control, and/or data connections to enable appropriate communications on the external network.

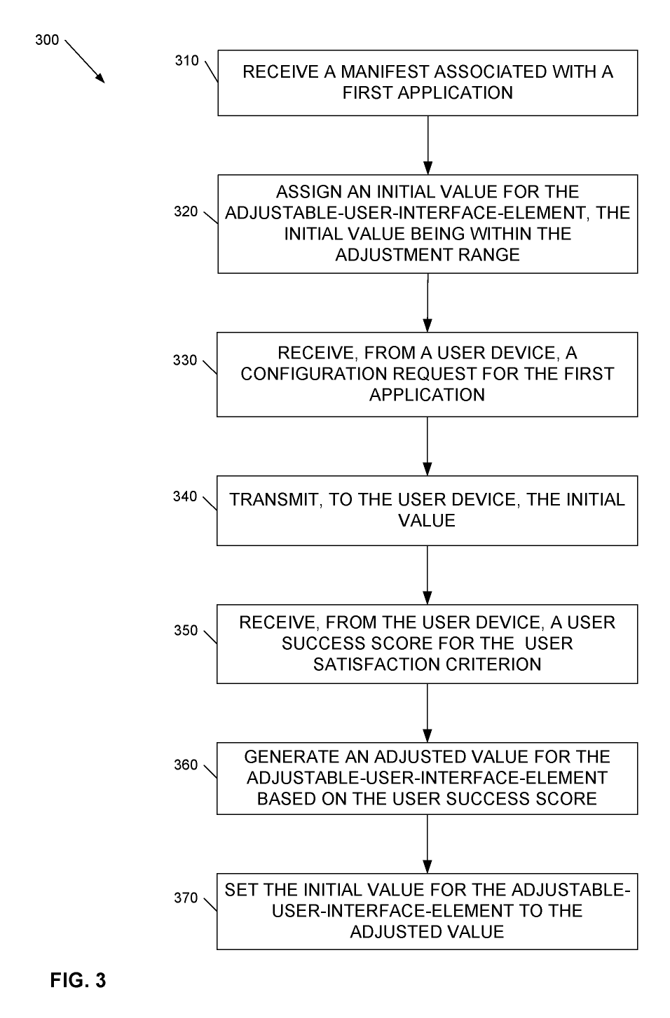

FIG. 3 is a flow chart of a method 300 for automatically improving the design-associated aspects of user interface elements of an application, in accordance with some embodiments. The method 300 is described as being performed by a single computing device 110, in particular, the electronic processor 202. However, it should be understood that in some embodiments, portions of the method 300 may be distributed across multiple computing devices or may be performed by other devices, including for example, first device 132 and the second device 134. As an example, the method 300 is described in terms of a single adjustable-user-interface-element and a single user device. However, the systems and methods described herein may be used with applications having multiple adjustable-user-interface-elements, with multiple applications, with multiple applications spread across multiple user devices, and combinations thereof.

At block 310, the computing device 110 receives a manifest associated with a first application. In one example, the manifest includes (i) an element indicator corresponding to an adjustable-user-interface-element of the first application, (ii) an adjustment range associated with the adjustable-user-interface-element, and (iii) a user satisfaction criterion associated with the adjustable-user-interface-element. In some embodiments, more than one criterion is (or criteria are) associated with each adjustable-user-interface element. Adjustable-user-interface-elements are elements of the user interface for the application. For example, the adjustable-user-interface-element may be a font, an image, a text label, a control element, and the like. Control elements are elements (for example, buttons, scroll bars, slider controls, menus, and the like), which users select or manipulate to provide input, retrieve output, respond to queries, navigate the application, and the like. Adjustable-user-interface-elements have characteristics that may be adjusted in some way to alter their appearance or performance within the application's user interface. For example, for text elements, the font's size (for example, in points) may be increased or decreased; the font's type (for example, bold, underlined, italicized) may be activated or deactivated; or a different font altogether may be selected for the text element. In another example, the size of an image may be increased or decreased. In yet another example, the size of a menu, or the options presented in the menu, may be adjusted. In another example, the size of a button may be increased or decreased. In another example, the color, or aspects of a color (for example, saturation, temperature, hue, and the like) of an element may be changed. In another example, the sensitivity or resolution of a control (for example, a slider control) may be increased or decreased. In some embodiments, an adjustable-user-interface-element may apply to portions of the user interface or to the interface as it appears throughout the application. For example, an adjustable-user-interface-element may be a color scheme or theme, a contrast ratio, the spacing within or between various elements or objects (for example, relative to one another) within the user interface, and the like. In some embodiments, a combination of element characteristics may be adjusted together (for example, the size and placement of an element or the color and size of a font). Each of the adjustable-user-interface-element has an associated adjustment range. The adjustment range may be based on practical considerations. For example, elements that are too small may be illegible or not selectable, while elements that are too large may not allow for placement of other elements within the interface. The adjustment range may also be based on design considerations or standards (for example, to maintain some level of consistent look and feel across a line of applications, or to maintain a brand identity).

A user satisfaction criterion is used to measure of a user's satisfaction with the adjustable-user-interface-element (for example, a key performance indicator associated with a user interaction with the first application). The user satisfaction criterion may be, for example, the time it takes a user to complete tasks associated with the adjustable-user-interface-element (for example, navigating the application, entering data, or choosing a menu item). In another example, user satisfaction criterion may be whether the user completes a particular action (associated with the adjustable-user-interface-element), or how often a particular action is taken. As described in detail below, user satisfaction is measured with a user success score based on the user satisfaction criterion.

After the manifest is received, an initial value (for example, within the adjustment range associated with an adjustable-user-interface-element) is assigned or selected (block 320). In some embodiments, the electronic processor 202 assigns the initial value based on a default value (for example, all text is defaulted to a 10 point font size), which may be provided in the manifest. In some embodiments, the electronic processor 202 assigns the initial value based one or more user satisfaction scores (as described in detail below), for example, as determined for one or more other similar applications using the method 300. In some embodiments, the electronic processor 202 assigns an initial value for the adjustable-user-interface-element based on a device characteristic associated with the user device. For example, a screen size or resolution of the user device may be used to determine the size of some elements. In some embodiments, the electronic processor 202 assigns the initial value at random from within the adjustment range. In some embodiments, the electronic processor 202 assigns a weight to several possible initial values, and selects one based on the weight (for example, values generated using the method 300 may be preferred to default values specified by a developer). In some embodiments, a combination of approaches is used.

At block 330, the electronic processor 202 receives a configuration request (for example, from a user device 132, which is running the first application) for the first application. The configuration request is a request from the application for user interface element configuration (for example, the value for the adjustable-user-interface-element). At block 340, the computing device 110 transmits the initial value (assigned at block 320) to the user device 132.

The user device 132 executes the application using the initial value for the corresponding adjustable-user-interface-element, and collects data about the user interaction with the application. In some embodiments, the user device 132 uses this data to generate a user success score for the user satisfaction criterion. As noted above, the user satisfaction criterion is used to measure of a user's satisfaction with the adjustable-user-interface-element, as currently configured with the initial value. User satisfaction may be represented with a user success score that is based on the user satisfaction criterion. In some embodiments, the user success score may indicate a quantity (for example, how many times an action associated with the adjustable-user-interface-element was taken), weighted with a strength indicator determined for the user satisfaction criterion. For example, the user took an action 3 times (with strength of +0.3), which indicates that the user was having a somewhat positive experience with the application. In another example, the user took a different action 7 times (with strength of −0.9), which indicates they were having a very negative experience with the application. In other embodiments, the user success score may be a measure of the time taken to perform a task or tasks associated with the adjustable-user-interface-element, with a shorter time receiving a higher score, and a longer time receiving a lower score. In some embodiments, user satisfaction scores based on times to perform may be weighted (for example, based on a complexity, importance, or some other characteristic of the task).

At block 350, the electronic processor 202 receives the user success score for the user satisfaction criterion from the user device. In some embodiments, the electronic processor 202 receives the data collected by the user device about the user interaction with the application, and generates the user success score from the data. Regardless of how the user success score is determined, at block 360, the electronic processor 202 generates an adjusted value for the adjustable-user-interface-element based on user success score. In some embodiments, when multiple user satisfaction scores are generated for a single initial value for the adjustable-user-interface-element (for example, when a plurality of user devices run the same iteration of the application and return results to the computing device 110), the electronic processor 202 may sum, average, or otherwise process multiple scores to generate a composite user success score. In some embodiments, the electronic processor 202 generates the adjusted value by comparing the user success score to a user success score for the previous iteration. For example, a button size of 50 pixels may receive a user success score of +0.5, and the same button sized at 45 pixels, in a subsequent iteration, may receive a user success score of +0.3. Based on the reduction in the user success score, the electronic processor 202 may generate an adjusted value of 47 pixels.

In some embodiments, the electronic processor 202 may use the user success score to determine the initial value for one or more other applications (for example that are similar to the application currently being improved).

At block 370, the electronic processor 202 sets the initial value for the adjustable-user-interface-element to the adjusted value. This new initial value may then be sent to the user device, to determine a new user success score based on the new initial value. As described in detail below, by successive iterations of the method 300, the electronic processor can determine the preferred value for the adjustable-user-interface-element (for example, the preferred size, shape, or placement of a button).

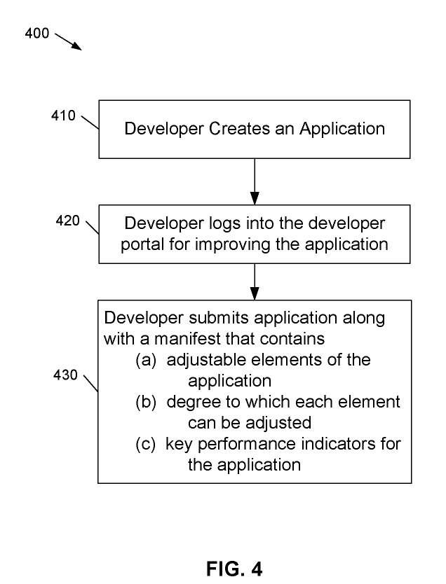

FIG. 4 illustrates an example flow diagram of an interaction between a developer portal 125 and the system 100 in FIG. 1, in accordance with some embodiments. In one example, the developer 120 creates an application (block 410). The developer 120 logs into the developer portal 125 to use the automated improvement service provided by the system 100 (block 420). The developer 120 submits an application along with a manifest, which contains (i) the adjustable elements of the application, (ii) the degree to which each element can be adjusted, and (iii) the key performance indicators for the application (block 430).

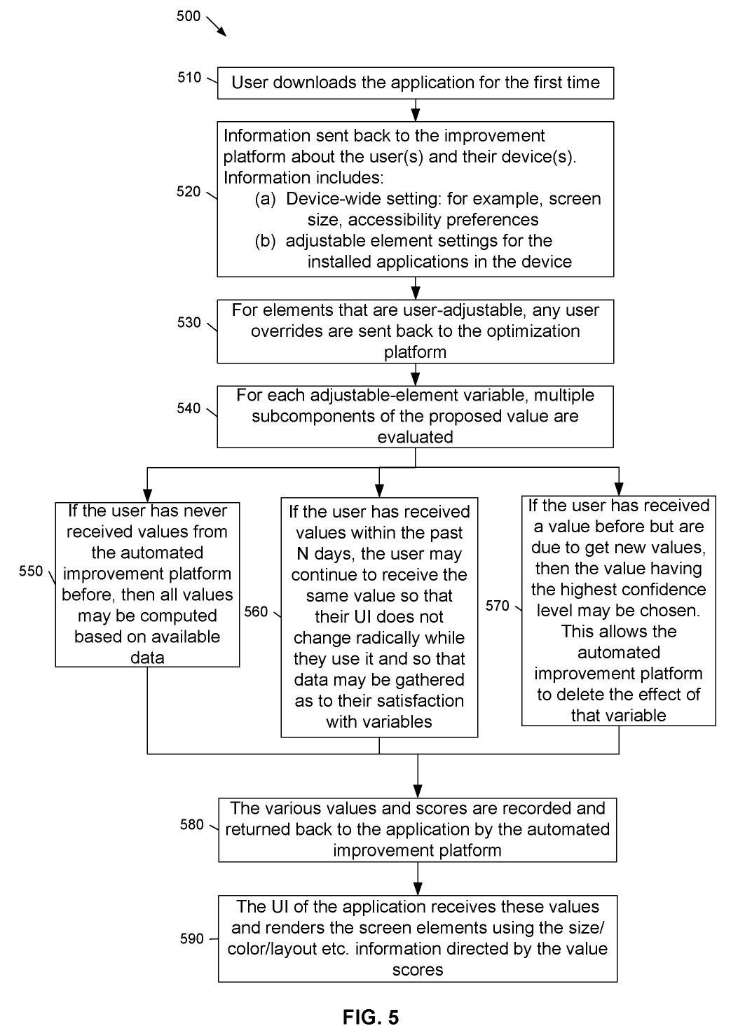

FIG. 5 illustrates an example flow diagram of an interaction between the user 130 and the system 100 shown in FIG. 1, in accordance with some embodiments. A user accesses or downloads the app for the first time, with no previous applications for reference (block 510). The user downloads the app onto their first device. Details such as information related to the user, the user's device, and the application used by the user are sent back to the system 100. Information that is sent to the system 100 may include (i) device-wide settings (for example, screen size/accessibility preferences), and (ii) adjustable element settings for other applications installed (block 520). If there are elements that may be adjusted by the user then such user overrides may be sent back to the system 100 and system 100 will not change these elements further (block 530). For each adjustable element variable, multiple subcomponents of the proposed value are evaluated the device settings are analyzed to determine if the value should be made smaller or bigger (for example, if the physical screen is smaller, and apps on that device are typically run with a larger font size, a larger font size may be used by default) (block 540). The user settings (including usage of other apps) are analyzed to see if the user has a general preference (for example, they typically prefer slightly larger font sizes). Other users' current values for this app are analyzed and the default is taken (for example, to determine if users generally prefer larger font sizes in this app). The user's previous history is considered (for example, if the user previously had a smaller font size assigned and their satisfaction was measured to be lower, then a larger font size may be assigned). At this point, the data is summed to comprise a single proposed value based on weighted inputs above. Confidence levels in the change may be recorded, for example the system is 90% confidence a given variable should be changed. A small randomization element may be introduced so that users try values they might not otherwise. If the user has never received values from the service before, then all values may be computed based on available data (block 550). If the user has received values within the past N days, the user may continue to receive the same value so that their user interface does not change radically while they use it and so that data may be gathered as to their satisfaction with variables (block 560). If the user has received a value before but are due to get new values, then the value with the highest confidence change would be chosen. In some instances, it may be statistically easier to change one variable at a time to isolate the effect of that variable) (block 570). The various values and scores are recorded, and are returned back to the application by the automated improvement platform (block 580). The user interface of the app receives these values and renders the screen elements using the size/color/layout etc. information dictated by the value scores (block 590).

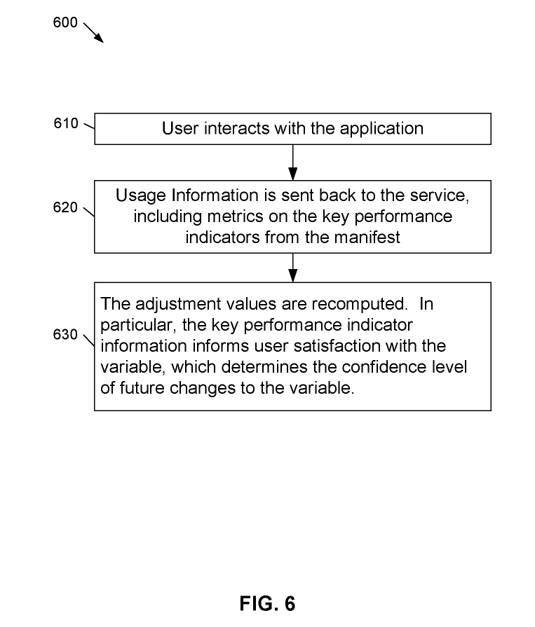

FIG. 6 illustrates an example flow diagram of a user interaction with an application, in accordance with some embodiments. At block 610, a user (for example, User A 130 or User B 140) interacts with the application. At block 620, the usage information is sent back to the automated improvement service including metrics on the key performance indices from the manifest. At block 630, the adjustment values are recomputed. In particular, the key performance indicator information (for example, including user success scores) informs user satisfaction with regard to a variable, which in turn determines the confidence level of future changes to the variable.

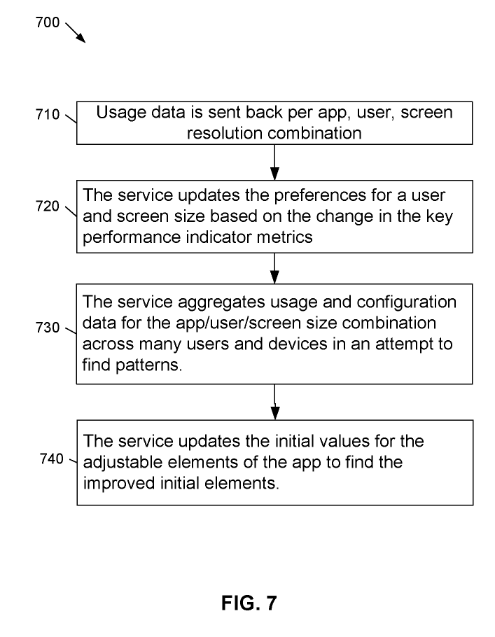

FIG. 7 illustrates an example flow diagram of an interaction between the automated improvement platform100 and an application used by a user (for example, User A 130 or User B 140), in accordance with some embodiments. At block 710, the usage data is sent back per application, user, and screen resolution combination. At block 720, the automated improvement service updates the preferences for a user and screen size based on the changes in the key performance indicator metrics (for example, user success scores). At block 730, the automated improvement service aggregates usage and configuration data for the application/user/screen size combination across many users and devices in an attempt to find patterns. In one example, this aggregation is not limited to a single application or developer, but across any application utilizing the automated improvement service. In some embodiments, a single value for a variable (for example, font size) may be chosen as the default for all users. In other embodiments, different values for that variable may be chosen depending on an aspect of user configuration (for example, a user's preferred or current screen resolution). At block 740, the automated improvement service updates the initial values for the adjustable elements of the application to find the preferred initial elements. In one embodiment, automated improvement service updates to the initial values and may only apply for a subset of users. In one example, all users with a particular screen size may have their initial values set to be different from other users. In another example, a particular user may have their menu set in a particular way based on that user's preference on other screen sizes.

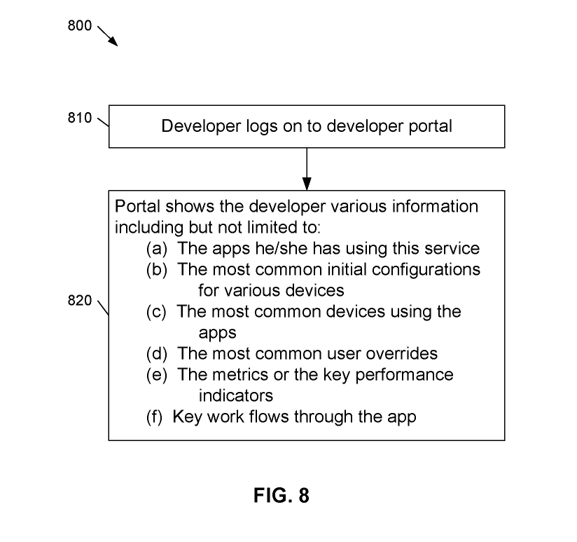

FIG. 8 illustrates an example flow diagram of an interaction between the developer portal 125 and the automated improvement platform100, in accordance with some embodiments. At block 810, the developer 120 logs onto the developer portal 125. The developer portal 125 is configured to show the developer various information including but not limited to: (a) the applications that the developer has that are using the automated improvement service provided herein, (b) the most common initial configurations for various devices, (c) the most common initial configurations for various devices, (d) the most common user overrides, (e) the metrics or key performance indicators, and (f) key work flows through the application (block 820).

One example of the workings of the automated improvement system 100 as seen by a developer, Bob, is provided below:

When Bob wants to develop an app, he decides to develop it using these design improvement capabilities. While Bob is creating the user interface, he takes note of the various elements and design blocks used throughout the app. Some examples of this may be the sign in button, sign in with a 3^{rd} party service and sign up buttons on the home page which each lead to their own subpages, and the Forgot your password link on the “Sign in” subpage.

Bob also creates a list of the key metrics he is interested in for this app. Examples of the metrics that Bob may chooses are the number of people that successfully sign in, the number of clicks on areas of the user interface that don't do anything and the number of clicks on the “back” button. Following which, Bob finishes and publishes his app for public use.

Bob signs in to the service tools a month after publishing the application. These tools allow him to view various stats about his application. The first thing he sees is that there are now several different variations of the user interface design. He can view the most common designs. Bob sees that most users are now being shown a design with larger buttons. He goes into the analysis of this design. The tool shows him that users with this design are showing a reduction in the number of clicks on parts of the user interface that don't do anything. As there is no effect on the other metrics, Bob infers that the larger buttons are helping the user interact with the button more successfully, reducing the number of times people miss the button. This change has helped people sign in more easily.

Bob also sees that font sizes have been changed for some users. For some, the font sizes have been increased, which has resulted in less bounce away from the content pages. This seems to indicate that the font was previously too small, causing users to give up their attempts to read it. For other users, the font has been decreased, which has led to more users completing the given action.

The service may also suggest a more fundamental design change. For example, when a pattern has emerged among users that of the users who click the “Sign in” button, 45% of them then click the “Forgot your password?” link on the subpage next, the service may recommend moving the link from the subpage to the home page, to reduce the number of clicks needed for the users going through this flow. In another example, the system may address this by increasing the information verbosity for the user interface element (for example, replacing “Forgot your password?” with “Forgot your password? Get an email sent to you with a link to reset it.”).

Based on the data Bob finds, he may decide to make the configuration used by the most people the default configuration that users will get up front from now on. Bob creates and publishes another app using the same automated improvement platform. After the app has been live for a short period, he sees that there are several variations of the app. This is because the automated improvement process for several users has been sped up as they also used the first app, and their preferences from the first app were used to inform the experiments of the second app.

In some embodiments, a server may execute the software described herein, and a user may access and interact with the software application using a computing device. Also, in some embodiments, functionality provided by the software application as described above may be distributed between a software application executed by a user's portable communication device and a software application executed by another electronic process or device (for example, a server) external to the portable communication device. For example, a user can execute a software application (for example, a mobile application) installed on his or her smart device, which may be configured to communicate with another software application installed on a server.

In the foregoing specification, specific embodiments have been described. However, various modifications and changes may be made without departing from the scope of the embodiments set forth in the claims below. Accordingly, the specification and figures are to be regarded in an illustrative rather than a restrictive sense, and all such modifications are intended to be included within the scope of present teachings.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. A device or structure that is “configured” in a certain way is configured in at least that way, but may also be configured in ways that are not listed.

Thus, embodiments provide, among other things, systems and methods for automatically improving user interface element configurations. Various features and advantages of some embodiments are set forth in the following claims.

What is claimed is:

1. A system for automatically improving design-associated aspects of user interface elements, the system comprising:
an electronic processor configured to
receive a manifest associated with a first application, the manifest including
an element indicator corresponding to an adjustable-user-interface-element of the first application,
an adjustment range associated with the adjustable-user-interface-element, and
a user satisfaction criterion associated with the adjustable-user-interface-element;
assign an initial value for the adjustable-user-interface-element, the initial value being within the adjustment range;
receive, from a user device, a configuration request for the first application;
transmit, to the user device, the initial value;
receive, from the user device, a user success score for the user satisfaction criterion;
generate an adjusted value for the adjustable-user-interface-element based on the user success score; and
set the initial value for the adjustable-user-interface-element to the adjusted value.

2. The system of claim 1, wherein the adjustable-user-interface-element is selected from the group consisting of a font size, a font type, an image size, a menu size, a menu option, and a contrast ratio associated with the first application.

3. The system of claim 1, wherein the user satisfaction criterion includes a key performance indicator associated with a user interaction with the first application.

4. The system of claim 1, wherein the user device is selected from the group consisting of a smart phone, a smart watch, a tablet, and a laptop.

5. The system of claim 1, wherein the electronic processor is further configured to
receive, from the user device, a second user success score associated with a second adjustable-user-interface-element of a second application.

6. The system of claim 1, wherein the electronic processor is further configured to
generate one or more user interface elements for a second application based the user success score.

7. The system of claim 1, wherein the electronic processor is further configured to
assign an initial value for the adjustable-user-interface-element based on a device characteristic associated with the user device.

8. A method for automatically improving design-associated aspects of user interface elements, the method comprising:
receiving, with an electronic processor, a manifest associated with a first application, the manifest including
an element indicator corresponding to an adjustable-user-interface-element of the first application,
an adjustment range associated with the adjustable-user-interface-element, and
a user satisfaction criterion associated with the adjustable-user-interface-element;
assigning, with the electronic processor, an initial value for the adjustable-user-interface-element, the initial value being within the adjustment range;
receiving, from a user device, a configuration request for the first application;
transmitting, to the user device, the initial value;
receiving, from the user device, a user success score for the user satisfaction criterion;
generating, with the electronic processor, an adjusted value for the adjustable-user-interface-element based on the user success score; and
setting, with the electronic processor, the initial value for the adjustable-user-interface-element to the adjusted value.

9. The method of claim 8, wherein receiving the manifest includes receiving an element indicator corresponding to an adjustable-user-interface-element selected from the group consisting of a font size, a font type, an image size, a menu size, a menu option, and a contrast ratio associated with the first application.

10. The method of claim 8, wherein receiving the manifest includes receiving a key performance indicator associated with a user interaction with the first application.

11. The method of claim 8, wherein receiving a configuration request includes receiving a configuration request from one selected from the group consisting of a smart phone, a smart watch, a tablet, and a laptop.

12. The method of claim 8, further comprising:
receiving, from the user device, a second user success score associated with a second adjustable-user-interface-element of a second application.

13. The method of claim 8, further comprising:
generating one or more user interface elements for a second application based the user success score.

14. The method of claim 8, further comprising:
assigning an initial value for the adjustable-user-interface-element based on a device characteristic associated with the user device.

15. A non-transitory, computer-readable medium containing computer-executable instructions that when executed by one or more electronic processors cause the one or more electronic processors to:
receive a manifest associated with a first application, the manifest including
an element indicator corresponding to an adjustable-user-interface-element of the first application,
an adjustment range associated with the adjustable-user-interface-element, and
a user satisfaction criterion associated with the adjustable-user-interface-element;
assign an initial value for the adjustable-user-interface-element, the initial value being within the adjustment range;
receive, from a user device, a configuration request for the first application;
transmit, to the user device, the initial value;
receive, from the user device, a user success score for the user satisfaction criterion;
generate an adjusted value for the adjustable-user-interface-element based on the user success score; and
set the initial value for the adjustable-user-interface-element to the adjusted value.

16. The non-transitory, computer-readable medium of claim 15, further comprising computer-executable instructions that when executed by one or more electronic processors cause the one or more electronic processors to
receive an adjustable-user-interface-element selected from the group consisting of a font size, a font type, an image size, a menu size, a menu option, and a contrast ratio associated with the first application.

17. The non-transitory, computer-readable medium of claim 15, further comprising computer-executable instructions that when executed by one or more electronic processors cause the one or more electronic processors to
receive a manifest including a key performance indicator associated with a user interaction with the first application.

18. The non-transitory, computer-readable medium of claim 15, wherein the computer-executable instructions that when executed by one or more electronic processors cause the one or more electronic processors to
receive, from the user device, a second user success score associated with a second adjustable-user-interface-element of a second application.

19. The non-transitory, computer-readable medium of claim 15, wherein the computer-executable instructions that when executed by one or more electronic processors cause the one or more electronic processors to
generate one or more user interface elements for a second application based the user success score.

20. The non-transitory, computer-readable medium of claim 15, wherein the computer-executable instructions that when executed by one or more electronic processors cause the one or more electronic processors to
assign an initial value for the adjustable-user-interface-element based on a device characteristic associated with the user device.
